(19) United States
(12) Patent Application Publication
(10) Pub. No.: US 2004/0035730 A1
(43) Pub. Date: Feb. 26, 2004

(54) Shrinkwrap system

(76) Inventor: Othell Bickerstaff, Brownstown, MI (US)

Correspondence Address: ARNOLD S. WEINTRAUB, SUITE 2000, 38505 WOODWARD AVE., BLOOMFIELD HILLS, MI, 48304, US

(21) Appl. No.: 10/418,709

(22) Filed: Apr. 18, 2003

Related U.S. Application Data
(62) Division of application No. 08/710,200, filed on Sep. 13, 1996, now abandoned.

(51) Int. Cl. B65B 51/06; B65B 53/00; B65B 53/02; B32B 33/00; B65D 85/68

(52) U.S. Cl. 206/335; 53/441; 53/442; 53/139.5; 53/419; 206/497; 428/90

(57) ABSTRACT

A fuselage of an aircraft or other portion of a motive craft is sealed with a heat shrinkable film section. After the film section is emplaced, a double-sided adhesive strip or adhesive transfer is wrapped therearound. Then, adjoining sections of film are adhered to the tape or adhesive to form an overlap. When heat is applied to the film an airtight seal is formed. The adhesive film may be used to adhere together adjacent other sections of heat shrinkable sheets assembled in similar overlapping fashion. The heat shrinkable material may be pre-formed to loosely conform to the sections of the craft to which it is to be adhered. A plurality of such loosely conformable sections can be pre-packaged in a kit form having the adhesive medium disposed at the outer or free edges thereof. The heat shrinkable material may be a multi-layered material having a shrinkable first layer and a cushioning second layer.

### BACKGROUND OF THE INVENTION

1. Field of the Invention

The present invention relates to shrink-film packaging and, more particularly, to shrunk-on packaging for an assembled aircraft or portion thereof and a method of making the same utilizing heat-shrinkable polymer film.

2. Prior Art

In the past, large performed shipping covers made of canvas or some other weather-resistant material were either sprayed or installed over aircraft to enable extended storage periods and/or for shipment, particularly shipment overseas. However, such covers or spray-on materials were heavy and clumsy, making them difficult and relatively time-consuming to install and/or remove. In addition, such covers were relatively expensive, thereby significantly increasing the cost involved in storing and/or shipping an aircraft utilizing such covers. Further, once the performed covers were removed from the aircraft they had to be washed, dried and specially packed, thereby incurring additional time and expense. Moreover, while such covers functioned reasonably well, they were installed upon the aircraft utilizing strapping, belting and the like and, therefore, were not airtight. Therefore, additional special precautions had to be taken, particularly when shipping aircraft overseas, to prevent moisture and vapor penetration and/or corrosion.

To overcome these problems, and as disclosed in U.S. Pat. No. 4,763,783, the disclosure of which is hereby incorporated by reference, many of the disadvantages inherent in the above-described aircraft covers were overcome by packaging for an aircraft which comprised a heat shrinkable polymer film applied to and which tightly conformed to the aircraft to provide a strong, generally airtight cover. While the invention thereof has proven efficacious, difficulties are encountered in both holding overlapping sheets together; reducing moisture accumulation; and, quite often, in covering the ends of a fuselage when only portions of an aircraft are to be wrapped. Likewise, in many instances it is cumbersome and time consuming to wrap portions of an aircraft with both cushioning and film as taught in the aforementioned patent. The present invention attends to these and other problems.

### SUMMARY OF THE INVENTION

Briefly stated, the present invention comprises shrunk-on packaging for an assembled aircraft or portion thereof, and a method of using same, utilizing heat shrinkable polymer film.

In accordance herewith, the aircraft or portion thereof is wrapped with a plurality of separate sections of heat shrinkable polymer film. Adjoining sections of the film are, at least, partially overlapping to provide a generally continuous covering. The overlapped sections are adhered to one another using a “double-sided” adhesive tape or an adhesive transfer film. This technique in using double-sided adhesive tape or the transfer film is particularly advantageous for use in wrapping a fuselage of fixed wing aircraft, and entire winged aircraft, as well as wrapping a portion of or an entire helicopter.

According hereto, and in a first aspect hereof, initially, the open end(s) area of a fuselage is wrapped with a section of film. Thereafter, a “double-sided” tape or transfer film it wrapped around the end film section to facilitate adherence of the overlapping sheets of film to thereby seal off the open end(s) of the fuselage. Similar strips of tape or adhesive may be strategically placed on the aircraft to facilitate overlapping of other sheets. Once the film is in place, heat is applied to the heat shrinkable film sections to shrink the film to tightly conform it to the aircraft or portion thereof to provide a generally weather-tight covering. The heat fuses together the overlapping film sections.

In a further aspect hereof, the heat shrinkable film is defined by a multi-layered sheet comprising a first heat shrinkable layer and a flocked or cushioning layer secured to the first layer.

In a still further embodiment hereof, the present invention contemplates a “kit” of pre-cut sections of shrinkable film which may be taped or sewn together.

The foregoing summary, as well as the following detailed description of preferred embodiments, will be better understood when read in conjunction with the appended drawings. For the purpose of illustrating the invention, there is shown in the drawings an embodiment which is presently preferred, it being understood, however, that the invention is not limited to the specific methods and instrumentalities disclosed. In the drawings:

### BRIEF DESCRIPTION OF THE DRAWINGS

FIG. 1 is a perspective view of a fuselage with an end sheet of polymer film applied thereto;

FIG. 2 is a fragmentary view of a segment of a heat shrinkable material contemplated for use herein;

FIG. 3 is a plan view of a portion of an aircraft section showing the effect of heat on the material of FIG. 2 with an underlying adhesive strip applied; and

FIG. 4 is an exploded, perspective view of a pre-formed heat shrinkable material and adhesive as part of a kit.

### DESCRIPTION OF THE PREFERRED EMBODIMENTS

At the outset, and as disclosed in the above-referred to patent it is to be noted that the packaging and method of the present invention are equally applicable to any type of aircraft, including large or small size fixed wing aircraft, as well as helicopters, rotary aircraft, VSTOL aircraft or the like, as well as other motor crafts.

In the above-referred to patent, it is taught that with aircraft the first step in packaging is covering exposed, jagged or sharp edges, geometric discontinuities such as outwardly extending bolts or the like, and irregularly shaped areas such as radar and other antenna, fins or the like, with a protective material, preferably a foam material. However, and in accordance herewith, by using the heat shrinkable film of the present invention, the need to use a foam material may be reduced or totally eliminated. A protective tape or pieces of film may alternatively be employed for covering small areas, such as exposed-rivets (not shown). The use of the film contemplated for use herein does not preclude the use of a separate foam layer or extra film layer in addition to the basic film layer, where it is deemed necessary.

Typically, an aircraft or portions thereof is wrapped with a plurality of separate individual sections of a shrink film which are cut from a roll (not shown). The individual shrink film sections may be of any desired size or shape, depending upon the size and shape of the portion or area of the aircraft being wrapped. The individual sections of the shrink film may be pre-cut at a remote location and marked or tagged to correspond to particular areas of the aircraft around which they are to be wrapped. Alternatively, the individual shrink film sections may be cut on location at the time they are applied to the aircraft.

As also taught in the aforementioned patent, the shrink film sections are wrapped around the aircraft so that adjoining sections at least partially overlap each other to provide a generally continuous covering. The amount or width of the overlap varies, depending upon the circumstances, but preferably the width of the overlap varies, depending upon the circumstances, but preferably the width of the overlap is about two to six inches. It is also preferable, although not critical, that the overlapped portion be generally horizontal with the overlapping or outer film section being the top section and the underlying or inner film section being the lower section. This manner of overlapping helps to prevent moisture from penetrating the packaging through the seams formed by the overlapping of the shrink films sections.

One type of film utilized in connection with the embodiment of the patent, is a heavy duty grade of low density polyethylene which is adapted to shrink in both the lateral and longitudinal directions upon the application of heat. Preferably, the film 24 meets or exceeds Federal Specification L-P-378D, Plastic Sheet and Strip, Thin Gauge Polyolefin, Classified as Type N, Class 3, Grade B, Finish I. The preferred shrink film is approximately seven mils thick and may be obtained as a roll in a variety of widths extending from about ten feet to about forty feet, depending upon the size and shape of the aircraft 10, or portion(s) thereof, being packaged. The shrink film may include an ultraviolet inhibitor to protect and extend the life of the film from the effects of the sun.

It will be appreciated by those skilled in the art that while the this shrink film 24 may be used, such a film does require the use of a separate foam material.

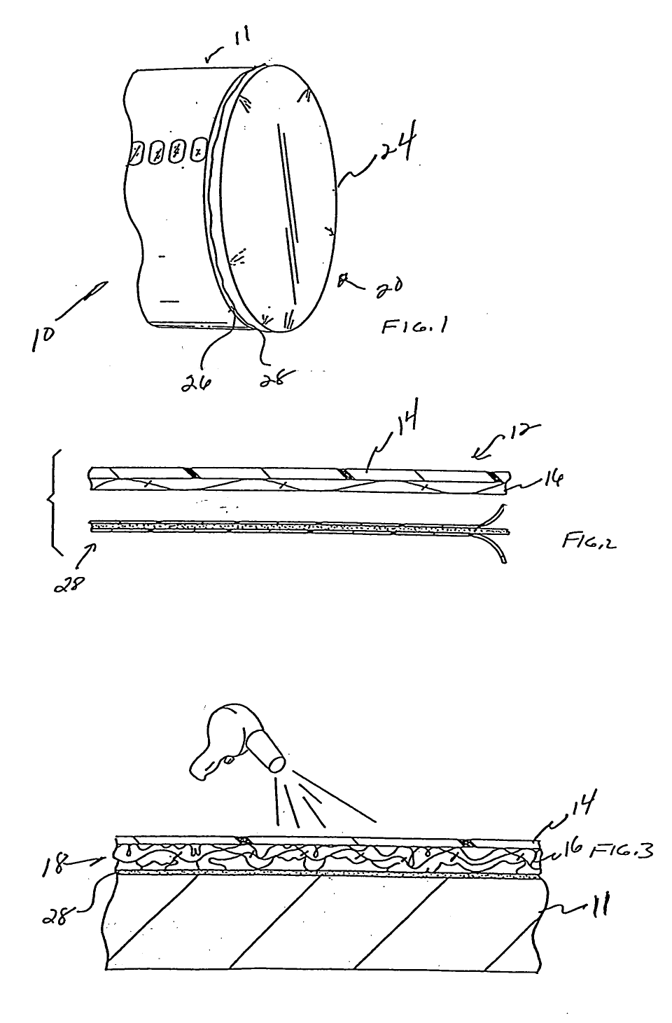

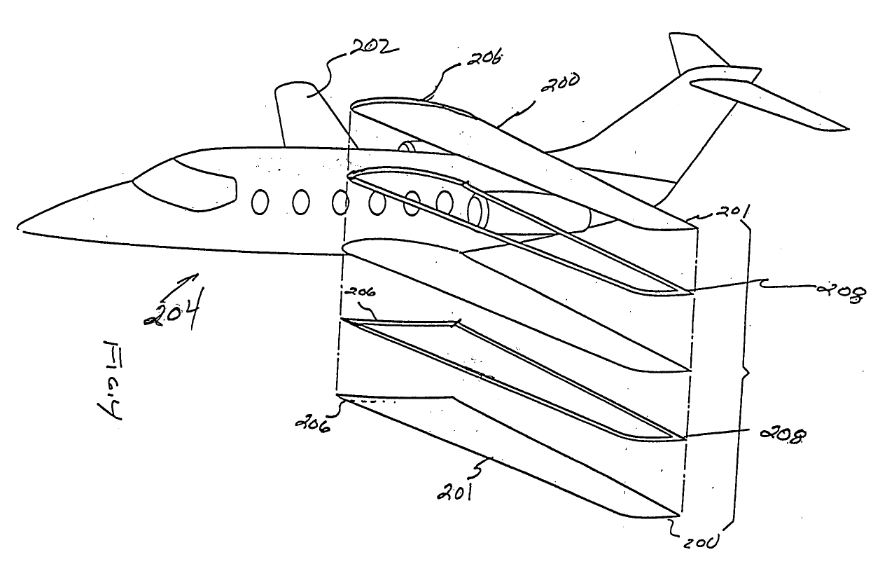

Thus, and in accordance herewith and as shown in FIGS. 1-3 in shrinkwrapping an aircraft or a portion thereof, there is provided a heat shrinkable material 12, comprising a two-layer material having a first outer or upper shrinkable layer 14 such as a polyester or the like to which is adhered a flock or other cushioning material second layer 16. Such material is well-known and commercially available, such as that sold under the name “Trans-Shield”. As shown in FIG. 3, this material may be heat shrunk while maintaining the integrity of the flock or cushioning layer. In essence, by applying heat to the material 12, as the shrinkable layer shrinks it causes an accumulation of the flock which then, in essence creates a cushion 18, as shown. By using this material for shrinkwrapping, the need for emplacement of a foam or cushioning materially about rotors, windows or the like is eliminated, thus, reducing the time necessary for shrinkwrapping the aircraft.

As noted above, and as shown in FIG. 1, the present invention in a first aspect hereof is directed to wrapping a fuselage 11, of the aircraft 10. The fuselage 11 has at least one open end 20 (only one of which is shown) for which a pre-cut sheet of film 24 is disposed therearound. In accordance herewith, the present invention enables other strips of film 26 to be securely adhered to the end sheet 24. An adhesive strip 28 is circumferentially disposed about the sheet 24. The adhesive strip 28 is either “a double sided” adhesive strip, i.e. has adhesive on both sides thereof or an adhesive transfer.

As is known to those skilled in the art, a double-sided adhesive is a multi-layer product defined by a medial strip having an adhesive deposited on both sides. An adhesive transfer is defined by a strip of cellulosic or other suitable material or medium having an adhesive deposited thereon, wherein the strip is removable therefrom. Once the adhesive is emplaced at the appropriate place, the medium is removed leaving only a layer of adhesive. Such product is well-known and commercially available.

Once the end piece 24 is taped, other fuselage covering sheets 26 are then, adhered thereto. Another similar strip of tape may be emplaced over the sheets 26 to facilitate overlapping thereof to form a horizontal seam (not shown).

As illustrated in FIG. 3, once the shrink film sheets have been wrapped around the fuselage, heat is applied to the sections of heat shrinkable film to shrink the film sections to tightly conform to the fuselage 11 of the aircraft 10 being packaged. Heretofore, it was customary to temporarily secure the film sections to the aircraft 10 prior to heating, using suitable straps or the like. The double-sided adhesive strips and/or transfer film 28 hereof eliminates the need for the straps. Preferably, the lower or underlying film sections are heated and shrunk prior to the shrinking of the upper or overlying sections.

The heat temperature required to shrink the film varies, depending upon the type and thickness of the shrink film employed and the determination thereof is within the ability of the skilled artisan When applying the heat, the operator should exercise caution and not apply too much heat at any one location to avoid burning holes through the shrink film 24. If holes or openings in the shrink film 24 are created, they may be patched utilizing an additional piece of shrink film and/or appropriate length of tape in a manner well known in the shrink film art.

As previously indicated, it is desirable to provide a shrink film package which is substantially airtight, and which will withstand extreme weather conditions and provide good protection for the enclosed fuselage 11.

Once the seams have been formed and the film shrunk it is possible to tape over each seam to protect the seam.

It is to be appreciated that the use of the “double-sided” tape and/or transfer film is applicable for adhering overlapping pre-cut sheets when wrapping other elements of the aircraft or an entire assembled aircraft. The present invention is, also, particularly advantageous for wrapping helicopters.

Thus, and in a further embodiment of the present invention, it has been discovered that it is not essential hereto that the aircraft be “wrapped” from sections cut at the site Rather, and in accordance with the present invention, there is provided pre-cut and pre-formed sections of material which are conformable to the various sections of the aircraft which are packaged as a kit. The “kit” comprises a plurality of loosely conforming, pre-formed heat shrinkable sections which can be rapidly emplaced over the various sections of the aircraft for which they are intended. By the term “loosely conforming” is meant a pre-formed section of heat shrinkable material configured to the section to which it is to be applied, but which has sufficient laxity in its conformation to enable it to be heat shrunk to closely fit the section to which it has been applied. As shown in FIG. 4 and, for example, a pre-formed section 200 loosely conforms to the configuration of a wing 202 of the aircraft 204. The section 200 may be heat shrunk to tightly adhere thereto in the manner described above. Likewise, preformed sections may be provided which loosely conform to the>configuration of the tail section. Also, further pre-formed sections may loosely conform to the configuration of the nacelle or nose of the aircraft. Clearly, other pre-formed sections may be provided. Likewise, such as with helicopters, rotor blade, fuselage, tail, nose, etc. pre-formed sections, may be provided.

The free edges 201 of the pre-formed sections 200 have an adhesive medium, either the double-sided tape or transfer film hereof, denoted at 206, secured thereto. Where the transfer film is used, the covering strip is emplaced thereon. The adhesive medium, be it the tape or transfer film enables rapid adherence of the various pre-formed sections together to enable both securement to the aircraft as well as to each other.

The sections of the sheet which are used to form the pre-formed sections may be sewn together or taped with a single-sided tape 208 or the like with the free edges, intended for overlapping, having the adhesive medium of either the double-sided tape or adhesive transfer 206 disposed thereat. By using the flocked material 12, as the outer or upper layer shrinks, the flock remains intact but further compacts together to increase the cushioning effect. By using pre-formed and pre-taped sections of such material the time necessary to shrink wrap an aircraft in considerably reduced.

It is to be appreciated that by employing the combined shrinkable and cushioning material as well as pre-formed sections, the present invention is not-limited to shrinkwrapping aircraft but can equally be applied to watercraft, and other vehicles, etc.

Having, thus, described the invention, what is claimed is:

1. In a method of shrink film packaging at least a portion of an aircraft of the type wherein sections of heat shrinkable film are emplaced over the at least one portion and, then, heat shrunk, the improvement which comprises:
(a) placing a sheet of film on the craft;
(b) applying an adhesive medium to the heat shrinkable film to expose an adhesive for adhering an overlapping sections of film thereonto;
(c) adhering the overlapping adjoining sections of film to the exposed adhesive thereafter,
(d) placing the overlapping sections of film providing a generally continuous covering, and
(e) applying heat to the heat shrinkable film sections to shrink the film to tightly conform to the aircraft portion to provide a generally airtight covering and to fuse together the overlapping film sections.

2. The improvement of claim 1 wherein the heat shrinkable film comprises:
a first layer of shrinkable film and a second layer of cushioning material, the first layer shrinking upon the application of heat thereto, the cushioning material compacting as the first layer shrinks.

3. The improvement of claim 1 which further comprises:
securing overlapping edges of the adjoining sections of film with a second adhesive medium.

4. The improvement of claim 1 wherein the adhesive medium is a double-sided adhesive tape.

5. The improvement of claim 1 wherein the adhesive medium is an adhesive transfer.

6. A kit for shrinkwrapping a motive craft, comprising:
(a) a plurality of pre-formed heat shrinkable sections of material, the heat shrinkable sections loosely conforming to the configuration of portions of a craft to which it is to be applied, and
(b) each of the sections having applied thereto an adhesive medium about the free edges thereof.

7. The kit of claim 3.wherein the material comprises a double-layered material having a heat shrinkable outer layer and a second layer comprising a cushioning flock.

8. The kit of claim 7 wherein the adhesive medium is double-sided adhesive tape.

9. The kit of claim 7 wherein the adhesive medium is an adhesive transfer.
